(19) United States
(12) Patent Application Publication
(10) Pub. No.: US 2026/0100537 A1
(43) Pub. Date: Apr. 9, 2026

(54) ELECTRICAL CONNECTOR AND ELECTRICAL CONNECTOR ASSEMBLY

(71) Applicant: FCI USA LLC, Etters, PA (US)

(72) Inventors: Yong Zhang, Nantong (CN); Hualin Hu, Dongguan City (CN)

(73) Assignee: FCI USA LLC, Etters, PA (US)

(21) Appl. No.: 19/086,855

(22) Filed: Mar. 21, 2025

(30) Foreign Application Priority Data
Oct. 8, 2024 (CN) 202411395158.3
Oct. 8, 2024 (CN) 202422430317.0

(51) Int. Cl. H01R 13/627; H01R 13/50; H01R 13/629

(52) U.S. Cl. CPC H01R 13/6275; H01R 13/50; H01R 13/629

(57) ABSTRACT

The present application provides an electrical connector and electrical connector assembly. The electrical connector may comprise: an insulating housing comprising an insulating housing main body and a plurality of insulating tubular members which are configured to protrude from the insulating housing main body and arranged in one or more rows on the insulating housing main body, each row of insulating tubular members constituting an insulating tubular members group; a securing structure disposed on at least one end of at least one of the insulating tubular members groups in an extending direction thereof; a plurality of mating contacts accommodated in each of the insulating tubular members.

### CROSS-REFERENCE TO RELATED APPLICATIONS

This application claims priority to and the benefit of Chinese Patent Application No. 202422430317.0, filed on Oct. 8, 2024, entitled “ELECTRICAL CONNECTOR AND ELECTRICAL CONNECTOR ASSEMBLY.” This application also claims priority to and the benefit of Chinese Patent Application No. 202411395158.3, filed on Oct. 8, 2024, entitled “ELECTRICAL CONNECTOR AND ELECTRICAL CONNECTOR ASSEMBLY.” The contents of these applications are incorporated herein by reference in their entirety.

### TECHNICAL FIELD

The present disclosure relates generally to the technical field of electrical connectors, specifically to an electrical connector and electrical connector assembly.

### BACKGROUND

This section provides background information relevant to the present application, which does not necessarily constitute prior art.

In the related art, electrical connectors are mainly used to connect two or more electronic devices together to provide a reliable electrical connection. Electrical connectors are used in a wide range of applications including, but not limited to, electronics, communications technology, vehicles, aerospace, etc.

In the technical field of power supply power connections, especially in power connections involving alternating current (AC) used for higher currents, it is desired to have higher performance in electrical connectors in terms of reliability of mechanical and electrical connections, ease of maintenance, etc.

Electrical connectors used for AC power connections also require high interface precision of the mated electrical connectors. It is desired to interface more precisely during the unplugging and plugging process of the electrical connectors to avoid misalignment or damage. In addition, the wires for transmitting AC power are usually a plurality of cables, and especially if the cables are heavy or the frequent unplugging and plugging is performed, the electrical connector may loosen or fall off during use, seriously affecting the normal operation of the equipment. On the one hand, if the mechanical connection strength of the electrical connector is reduced, the electrical connector may produce unstable electrical contact, which in turn affects the reliability of the signal transmission of the electrical connector, and may produce problems such as the speed reduction of data transmission terminals, or communication errors. On the other hand, if the mechanical connection strength of the electrical connector is reduced, this may result in poor contact between the contacts of the electrical connector, and the electrical connector may incur additional losses when transmitting current, resulting in an increase in the power consumption of the electronic device. There is a need for an electrical connector that can carry a large AC while providing reliable mechanical and electrical connections.

### SUMMARY

This section provides a general overview of the present application, rather than a full disclosure of the full scope or features of the present application.

A first aspect of the present application provides an electrical connector which may comprise: an insulating housing comprising an insulating housing main body and a plurality of insulating tubular members which are configured to protrude from the insulating housing main body and arranged in one or more rows on the insulating housing main body, each row of insulating tubular members constituting an insulating tubular members group; a securing structure disposed on at least one end of at least one of the insulating tubular members groups in an extending direction thereof; a plurality of mating contacts each accommodated in each of the insulating tubular members.

With the electrical connector of the present application, the plurality of insulating tubular members are configured to protrude from the insulating housing main body and the plurality of mating contacts each are accommodated in each of the insulating tubular members, such that mating contacts each are physically separated from each other by the insulating housing main body and electrically isolated from each other by the insulating tubular members. The insulating housing main body allows to secure the insulating tubular members at intervals, which ensures that the mating contacts accommodated in the insulating tubular members are secured to each other in a manner that they are spaced apart from each other, thereby realizing reliability in terms of mechanical and electrical connections. In some exemplary embodiments, the plurality of insulating tubular members may have a cylindrical shape.

In some exemplary embodiments, the electrical connector may be a receptacle connector, and the mating contact comprises a mating component and a tail component; the mating component comprises, on one end of the mating component, a cup-shaped metal structural member and a metal elastic deformation member mounted on the metal structural member, the metal elastic deformation member being deformed by being squeezed by a complementary member when the complementary member is inserted in the metal structural member.

In the case where the electrical connector of the present application is a receptacle connector, the mating component comprises, on one end of the mating component, a cup-shaped metal structural member and a metal elastic deformation member mounted on the metal structural member, and the metal elastic deformation member is deformed by being squeezed by a complementary member when the complementary member is inserted in the metal structural member. In such a manner, the metal elastic deformation member will generate a counter-acting force inwardly along a radial direction of the insulating tubular member on an inserted complementary member (e.g., a mating contact of a plug connector), which further retains the complementary member firmly inside the mating component, thus ensuring a high degree of reliability of the electrical connector in terms of mechanical and electrical connections. In particular, the electrical connector of the present application is suitable to be used as an electrical connector for AC power connections, and can ensure a high degree of reliability and stability of the electrical and mechanical connections between the mating contact of the receptacle connector and the complementary member, even in the case of heavy cables, inadvertent pulling or frequent unplugging and plugging, and the like.

In some exemplary embodiments, the metal elastic deformation member may comprise at least one deformation portion extending from an inner peripheral wall of the metal structural member to a center of the metal structural member, the deformation portion being deformed by being squeezed by a complementary member when the complementary member is inserted in the metal structural member.

In the case where the electrical connector of the present application is a receptacle connector, the metal elastic deformation member comprises at least one deformation portion extending from an inner peripheral wall of the metal structural member to a center of the metal structural member, and the deformation portion is deformed by being squeezed by a complementary member (e.g., a mating contact of a plug connector) when the complementary member is inserted in the metal structural member. Such a configuration enables a greater retention force to be generated for the complementary member inserted into the metal structural member, and thus enables the complementary member to be more firmly retained inside the mating component, thereby further providing more secure and reliable mechanical and electrical connections. In particular, the configuration where the electrical connector of the present application has a metal elastic deformation member can be reliably adapted to electrically connect for an AC of 50 A to 70 A (e.g., 60 A).

In some exemplary embodiments, the tail component may be disposed on the other end of the mating component.

In some exemplary embodiments, the deformation portion may be a plurality of tabs curved towards an interior of the metal structural member, the plurality of tabs being formed by cutting the metal elastic deformation member.

In the case where the electrical connector of the present application is a receptacle connector, the deformation portion is configured as a plurality of tabs curved towards an interior of the metal structural member. On the one hand, the plurality of tabs can provide a compliant force to allow smooth insertion of a complementary member (e.g., a mating contact of a plug connector) when the complementary member is inserted into the metal structural member, so as to allow the complementary member to be inserted more smoothly into the metal structural member and precisely aligned. On the other hand, the plurality of tabs can provide a strong retention force on an inserted complementary member after the complementary member is smoothly inserted into the metal structural member, which in turn firmly retains the complementary member inside the mating component, and can ensure stability and reliability of the electrical and mechanical connections between the complementary member and the mating contact of the receptacle connector, even in the case of heavy cables, inadvertent pulling or frequent unplugging and plugging, and the like.

In some exemplary embodiments, the metal elastic deformation member may be formed as a strip capable of being bent and inserted into the metal structural member, the strip being retained on the metal structural member by means of the insulating housing.

In some exemplary embodiments, the deformation portion is a protrusion disposed on the metal elastic deformation member.

In the case where the electrical connector of the present application is a receptacle connector, it is configured that the deformation portion is a protrusion disposed on the metal elastic deformation member. The protrusion is subjected to a force by being squeezed by a complementary member (e.g., a mating contact of a plug connector) when the complementary member is inserted into the metal structural member, which further causes the metal elastic deformation member to deform elastically and thus generate a counter-acting force inwardly along a radial direction of the insulating tubular member on the complementary member inserted into the metal structural member. Therefore, the complementary member can be more firmly retained within the mating component, thereby further providing more secure mechanical and electrical connections.

In some exemplary embodiments, the metal elastic deformation member may be formed to enclose at least a portion of the metal structural member.

In some exemplary embodiments, a peripheral wall of the metal structural member may be disposed with an opening through which the protrusion protrudes into an interior of the metal structural member.

In some exemplary embodiments, the protrusion may be a rib formed on the metal elastic deformation member.

In some exemplary embodiments, the protrusion may be a rib formed on the metal elastic deformation member by an embossing process.

In some exemplary embodiments, the tail component may be configured to receive a cable or be mounted to a printed circuit board.

In some exemplary embodiments, in the event that the tail component may be configured to receive a cable, the electrical connector further has an overmolding member partially molded onto the cable and partially molded onto the insulating housing to hold the received cable.

In the case where the electrical connector of the present application is a receptacle connector, the receptacle connector comprises an overmolding member partially molded onto the cable and partially molded onto the insulating housing to hold the received cable, and thus it is possible to mold the tail component of the mating contacts of the electrical connector into a desired shape according to the needs of the actual connection. In some embodiments, the tail component molding may be made by injection molding using a plastic material, which allows the tail component of the mating contacts to be easily molded into the desired shape due to the flexibility of the injection molding process for plastic members.

In some exemplary embodiments, the securing structure may comprise a latching mechanism mounted to the insulating housing or a latch fastener formed on the insulating housing.

In some exemplary embodiments, the latching mechanism may comprise an outer shell and a latch capable of being pivotally mounted within the outer shell.

In the case where the electrical connector of the present application is a receptacle connector, the securing structure comprises a latching mechanism. The latch allows to put the electrical connector (e.g., a receptacle connector and a plug connector mating with each other) into a locked state or into an unlocked state. With the electrical connector of the present application, the provision of the latching mechanism is capable of ensuring the reliability of the electrical connector in terms of mechanical and electrical connections while allowing an operator to quickly lock and unlock the electrical connector. The electrical connector includes a latching mechanism disposed on at least one end of at least one of the insulating tubular members groups in an extending direction thereof, thereby allowing an operator to quickly lock and unlock the electrical connector even when operating space is limited.

In some exemplary embodiments, the securing structure may be a nut or a screw mounted to the insulating housing.

In some exemplary embodiments, the insulating housing may comprise a flange having a through-hole.

In some exemplary embodiments, a threaded connecting member may be inserted into the through-hole to connect the electrical connector to a printed circuit board.

In some exemplary embodiments, a threaded connecting member may be inserted into the through-hole to connect the electrical connector to a mating connector.

In some exemplary embodiments, a guiding projection is disposed on an outer peripheral surface of the insulating tubular member along a plugging and unplugging direction.

In the case where the electrical connector of the present application is a receptacle connector, a guiding projection is disposed on an outer peripheral surface of the insulating tubular member along a plugging and unplugging direction, for cooperating with the guiding recess of a mating plug connector, such that the receptacle connector can be precisely aligned with the mating plug connector, preventing misalignment between the receptacle connector and the plug connector due to improper insertion caused by, for example, skewing of the insertion direction, or the like.

In some other exemplary embodiments, the electrical connector may be a plug connector, and the mating contact comprises a mating component and a tail component, the mating component comprising an elongate metal structural member.

In some other exemplary embodiments, the mating component may be a tubular member, the mating component having an insulating cover member on one end of the mating component. The tail component extends from the other end of the mating component.

In the case where the electrical connector of the present application is a plug connector, the mating component has an insulating cover member on one end of the mating component, which can prevent accidental contact with the elongate metal structural member of the mating component, thereby providing effective protection of the elongate metal structural member of the mating component.

In some other exemplary embodiments, a part of the plurality of mating components may have a longer length than other mating components of the plurality of the mating components.

In the case where the electrical connector of the present application is a plug connector, it may be disposed that a part of the plurality of mating components has a longer length than other mating components of the plurality of the mating components, for specifically designed uses. For example, in some embodiments, the longer mating component may be used for a grounding component or a neutral wire.

In some other exemplary embodiments, the tail component may be configured to receive a cable or be mounted to a printed circuit board.

In some other exemplary embodiments, in the event that the tail component may be configured to receive a cable, the electrical connector may further have an overmolding member partially molded onto the cable and partially molded onto the insulating housing to hold the received cable.

In the case where the electrical connector of the present application is a plug connector, the plug connector comprises an overmolding member partially molded onto the cable and partially molded onto the insulating housing to hold the received cable, and thus it is possible to mold the tail component of the mating contacts of the electrical connector into a desired shape according to the needs of the actual connection. In some embodiments, the tail component molding may be made by injection molding using a plastic material, which allows the tail component of the mating contacts to be easily molded into the desired shape due to the flexibility of the injection molding process for plastic members.

In some other exemplary embodiments, the securing structure may comprise a latching mechanism mounted to the insulating housing or a latch fastener formed on the insulating housing.

In some other exemplary embodiments, the latching mechanism may comprise an outer shell and a latch capable of being pivotally mounted within the outer shell.

With the plug connector of the present application, the securing structure comprises a latching mechanism mounted to the insulating housing or a latch fastener formed on the insulating housing, such that the electrical connector can be put into a locked state or an unlocked state. With the electrical connector of the present application, the provision of the latching mechanism or a latch fastener is capable of ensuring the reliability of the electrical connectors mating with each other in terms of mechanical and electrical connections while allowing an operator to quickly lock and unlock the electrical connectors mating with each other. The electrical connector includes a latching mechanism or a latch fastener disposed on at least one end of at least one of the insulating tubular members groups in an extending direction thereof, thereby allowing and facilitating an operator to quickly lock and unlock the electrical connector even when operating space is limited.

In some other exemplary embodiments, the securing structure may be a nut or a screw mounted to the insulating housing.

In some other exemplary embodiments, the insulating housing may comprise a flange having a through-hole.

In some other exemplary embodiments, a threaded connecting member may be inserted into the through-hole to connect the electrical connector to a printed circuit board.

In some other exemplary embodiments, a threaded connecting member may be inserted into the through-hole to connect the electrical connector to a mating connector.

In some other exemplary embodiments, a guiding recess may be disposed on an inner peripheral surface of the insulating tubular member along a plugging and unplugging direction.

In the case where the electrical connector of the present application is a plug connector, a guiding recess may be disposed on an inner peripheral surface of the insulating tubular member along a plugging and unplugging direction, for cooperating with the guiding projection of a mating receptacle connector, such that the plug connector can be precisely aligned with the mating receptacle connector, preventing misalignment between the plug connector and the receptacle connector due to improper insertion caused by, for example, skewing of the insertion direction, or the like.

According to a second aspect of the present application there is also provided an electrical connector assembly, wherein the electrical connector assembly may comprise a receptacle connector and a plug connector disposed in pairs, the receptacle connector being a receptacle connector according to some embodiments of the first aspect of the application, and the plug connector being a plug connector according to some other embodiments of the first aspect of the application.

With the electrical connector assembly of the present application, the plurality of insulating tubular members of the receptacle connector and the plug connector disposed in pairs are configured to protrude from the insulating housing main body and the plurality of mating contacts each are accommodated in each of the insulating tubular members, such that mating contacts each are physically separated from each other by the insulating housing main body and electrically isolated from each other by the insulating tubular members. The insulating housing main body allows to secure the insulating tubular members at intervals, which ensures that the mating contacts accommodated in the insulating tubular members are secured to each other in a manner that they are spaced apart from each other, thereby realizing reliability in terms of mechanical and electrical connections.

In the assembly process of the electrical connector assembly of the present application, a guiding projection is disposed on an outer peripheral surface of the insulating tubular member of a receptacle connector, and a guiding recess is disposed on an inner peripheral surface of the insulating tubular member of a plug connector, such that the mating contacts of the plug connector and the receptacle connector are precisely aligned. Moreover, the metal elastic deformation member disposed on the receptacle connector is deformed by being squeezed by a mating contact of a plug connector when the mating contact of the plug connector is inserted in the metal structural member, such that the metal elastic deformation member will generate a counter-acting force inwardly along a radial direction of the insulating tubular member on an inserted mating contact of the plug connector, which further retains the mating contact of the plug connector firmly inside the mating component of the receptacle connector, thus ensuring a high degree of reliability of the electrical connector in terms of mechanical and electrical connections. In particular, the electrical connector of the present application is suitable to be used as an electrical connector for AC power connections, and can ensure a high degree of reliability and stability of the electrical and mechanical connections between the mating contact of the receptacle connector and the mating contact of the plug connector, even in the case of heavy cables, inadvertent pulling or frequent unplugging and plugging, and the like.

### BRIEF DESCRIPTION OF THE DRAWINGS

The features and advantages of embodiments of the present application will become easier to understand with the following description with reference to the accompanying drawings, which are not drawn in scale and some features are enlarged or reduced to show details of particular components, in which:

FIG. 1A illustrates a perspective view of an electrical connector according to some exemplary embodiments of the present application, wherein the electrical connector is a receptacle connector;

FIG. 1B illustrates a perspective view of an electrical connector according to some other exemplary embodiments of the present application, wherein the electrical connector is a plug connector;

FIGS. 2A and 2B illustrate exploded views of a receptacle connector according to some exemplary embodiments of the present application;

FIG. 3A is a schematic view of a mating contact of a receptacle connector according to some exemplary embodiments of the present application;

FIG. 3B is a partially enlarged view of a mating contact of a receptacle connector according to some exemplary embodiments of the present application;

FIG. 4A shows a schematic view of a further mating contact of a receptacle connector according to some exemplary embodiments of the present application;

FIG. 4B is an exploded view of a further mating contact of a receptacle connector according to some exemplary embodiments of the present application;

FIG. 5A is a schematic view of a securing structure of a receptacle connector according to some exemplary embodiments of the present application;

FIG. 5B is an exploded view of a securing structure of a receptacle connector according to some exemplary embodiments of the present application;

FIG. 6A and FIG. 6B are exploded views of a plug connector according to some other exemplary embodiments of the present application;

FIG. 7A and FIG. 7B are schematic views of a mating contact of a plug connector according to some other exemplary embodiments of the present application;

FIGS. 8A and 8B are schematic views of a plug connector according to alternative exemplary embodiments of the present application, viewed from different angles;

FIGS. 9A and 9B are schematic views of a plug connector according to yet other exemplary embodiments of the present application, viewed from different angles;

FIGS. 9C and 9D are schematic views of a plug connector according to yet some other exemplary embodiments of the present application, viewed from different angles;

FIG. 10 shows a schematic view of a receptacle connector according to some other exemplary embodiments of the present application;

FIG. 11 shows a schematic view of a receptacle connector according to yet other exemplary embodiments of the present application; and FIG. 12 shows a schematic view of a receptacle connector according to yet some other exemplary embodiments of the present application.

Reference signs are described as follows: 100 receptacle connector; 200 plug connector; 110 mating contact; 210 mating contact; 111 mating component; 211 mating component; 112 tail component; 212 tail component; 113 metal structural member; 213 insulating cover member; 114 metal elastic deformation member; 230 insulating housing; 115 deformation portion; 23 insulating housing main body; 116 protrusion; 232 insulating tubular member; 117 opening; 233 through-holes; 118 overmolding member; 240 securing structure; 130 insulating housing; 241 latch fastener; 131 insulating housing main body; 244 guiding recess; 132 insulating tubular member; 245 threaded connecting member; 135 screw; 2120 straight tail component; 14 securing structure; 2121 curved tail component; 141 latching mechanism; 247 securing member; 142 outer shell; 143 latch; 144 guiding projection; 145 arm; 146 elastic beam; 147 securing member; 148 protruding portion.

### DETAILED DESCRIPTION OF THE INVENTION

The present application will be described in detail below with reference to the drawings with the aid of exemplary embodiments of the present application. It should be noted that the following detailed description of the present application is for illustrative purposes only and is in no way a limitation of the present application. In addition, the same reference sign is used in each of the drawings to indicate the same component.

In the related art, in the field of power supply power connections, the wires used to transmit AC power are usually a plurality of cables, and especially if the cables are heavy or frequent unplugging and plugging is performed, the electrical connector may loosen or fall off during use. In the event that the mechanical connection strength of the electrical connector is reduced, the electrical connector may produce unstable electrical contact, which in turn affects the reliability of the signal transmission of the electrical connector, and may produce problems such as speed reduction of data transmission terminals, or communication errors. In addition, in the event that the mechanical connection strength of the electrical connector is reduced, this may result in poor contact between the contacts of the electrical connector, and the electrical connector may incur additional losses when transmitting current, resulting in an increase in the power consumption of the electronic device. Electrical connectors used for AC power connections also require high interface precision of the mated electrical connector. It is desired to interface more precisely during the unplugging and plugging process of the electrical connectors to avoid misalignment or damage. It is desired to realize an electrical connector that can carry large amounts of AC power and at the same time provide reliable and stable mechanical and electrical connections.

The inventor has recognized a technique for manufacturing an electrical connector capable of solving at least some of the technical problems in the related art, which is capable of carrying a large amount of AC power (e.g., an AC current of 50 A to 70 A) while at the same time providing reliable and stable mechanical and electrical connections.

In order to ensure the mechanical and electrical reliability of the mating contacts for transmitting AC power applicable in the field of power supply power connections, with the electrical connector of the present application, the plurality of insulating tubular members are configured to protrude from the insulating housing main body and the plurality of mating contacts each are accommodated in each of the insulating tubular members, such that mating contacts are each physically separated from each other by the insulating housing main body and electrically isolated from each other by the insulating tubular members. Thus, the insulating housing main body of the electrical connector of the present application allows securing the insulating tubular members at intervals, which ensures that the mating contacts accommodated in the insulating tubular members are secured to each other in a manner such that they are spaced apart from each other, thereby realizing reliability in terms of mechanical and electrical connections.

The receptacle connector of the present application has been designed in order to overcome the problem of weak connection of the mating contacts in the related art, which leads to a reduction in connection strength. Specifically, the mating component of the mating contact of the receptacle connector comprises, on one end of the mating component, a cup-shaped metal structural member and a metal elastic deformation member mounted on the metal structural member, and the metal elastic deformation member is deformed by being squeezed by a complementary member (e.g., a mating contact of a plug connector) when the complementary member is inserted in the metal structural member. By such a structural design, the metal elastic deformation member will generate a counter-acting force inwardly along a radial direction of the insulating tubular member on an inserted complementary member, which further retains the complementary member firmly inside the mating component, thus ensuring a high degree of reliability of the electrical connector in terms of mechanical and electrical connections. In particular, the electrical connector of the present application is suitable to be used as an electrical connector for AC power connections, and can ensure a high degree of reliability and stability of the electrical and mechanical connections between the mating contact of the receptacle connector and the complementary member, even in the case of heavy cables, inadvertent pulling or frequent unplugging and plugging, and the like.

Further, in order to ensure that the electrical connector can be reliably adapted to electrically connect for an AC of 50 A to 70 A (e.g., 60 A), the metal elastic deformation member of the electrical connector of the present application has been structurally designed in a particular way. Specifically, it the metal elastic deformation member may comprise at least one deformation portion extending from an inner peripheral wall of the metal structural member to a center of the metal structural member, and the deformation portion is deformed by being squeezed by a complementary member (e.g., a mating contact of a plug connector) when the complementary member is inserted into the metal structural member. Such a configuration of the metal elastic deformation member enables a greater retention force to be generated for the complementary member inserted into the metal structural member, and thus enables the complementary member to be more firmly retained inside the mating component, thereby further providing more secure and reliable mechanical and electrical connections.

In addition, in order to further ensure that the electrical connector can be reliably adapted to electrically connect for an AC of 50 A to 70 A (e.g., 60 A), the deformation portion of the metal elastic deformation member may be configured as a plurality of tabs curved towards an interior of the metal structural member. With the metal elastic deformation member in such a configuration, the plurality of tabs can provide a compliant force that allows smooth insertion of a complementary member (e.g., a mating contact of a plug connector) when the complementary member is inserted into a metal structural member, thereby allowing the complementary member to be inserted into the metal structural member more smoothly and aligned accurately. In addition, the plurality of tabs can provide a strong retention force on an inserted complementary member after the complementary member is smoothly inserted into the metal structural member, which in turn firmly retains the complementary member inside the mating component, and can ensure stability and reliability of the electrical and mechanical connections between the complementary member and the mating contact of the receptacle connector, even in the case of heavy cables, inadvertent pulling or frequent unplugging and plugging, and the like.

The inventor has realized and understood that, in order to be able to lock and unlock the electrical connector quickly while ensuring reliable mechanical and electrical connections, the electrical connector may include a securing structure. In some embodiments, the securing structure of the electrical connector of the present application (e.g., a receptacle connector or a plug connector) comprises a latching mechanism. The latch is able to put the electrical connector (e.g., a receptacle connector and a plug connector mating with each other) in a locked state or in an unlocked state. With the electrical connector of the present application, the latching mechanism is capable of ensuring the reliability of the electrical connector in terms of mechanical and electrical connections while allowing an operator to quickly lock and unlock the electrical connector. The electrical connector includes a latching mechanism disposed on at least one end of the electrical connector, for example on at least one of the insulating tubular members groups in an extending direction thereof, thereby allowing an operator to quickly lock and unlock the electrical connector even when space is limited.

A particular structural design has been made for the electrical connector of the present application in order to provide precise positioning of the connection of the electrical connector. Specifically, for a receptacle connector, a guiding projection may be disposed on an outer peripheral surface of the insulating tubular member along a plugging and unplugging direction, and for a plug connector, a guiding recess may be disposed on an inner peripheral surface of the insulating tubular member along a plugging and unplugging direction. The guiding projection of the receptacle connector is complementary to the guiding recess of the mating plug connector, such that the receptacle connector can be precisely aligned with the mating plug connector, preventing misalignment between the receptacle connector and the plug connector due to improper insertion caused by, for example, skewing of the insertion direction, or the like.

A particular structural design has been made for the plug connector of the present application in order to enable the electrical connector to be suitable for various types of cable connections. The plug connector may comprise an overmolding member partially molded onto the cable and partially molded onto the insulating housing to hold the received cable, and thus it is possible to mold the tail component of the mating contacts of the electrical connector into a desired shape according to the needs of the connection. In some embodiments, the tail component molding may be made by injection molding using a plastic material, which allows the tail component of the mating contacts to be easily molded into the desired shape due to the flexibility of the injection molding process for plastic members.

The electrical connector and the electrical connector assembly according to some embodiments of the present application will be described in detail below in conjunction with the accompanying drawings.

For the sake of clarity and conciseness of description, a plugging and unplugging direction X in which the plug connector of the present application is inserted into the receptacle connector or in which the plug connector is withdrawn from the receptacle connector, a direction Y perpendicular to the plugging and unplugging direction X (i.e., a lengthwise direction Y of the insulating housing main body of the electrical connector), and a direction Z perpendicular to the plugging and unplugging direction X and the lengthwise direction Y (i.e., a width direction Z of the insulating housing main body of the electrical connector) are labeled in the drawings.

A first aspect of the present application provides an electrical connector. An electrical connector according to an embodiment of the present application is described in detail below in conjunction with the accompanying drawings.

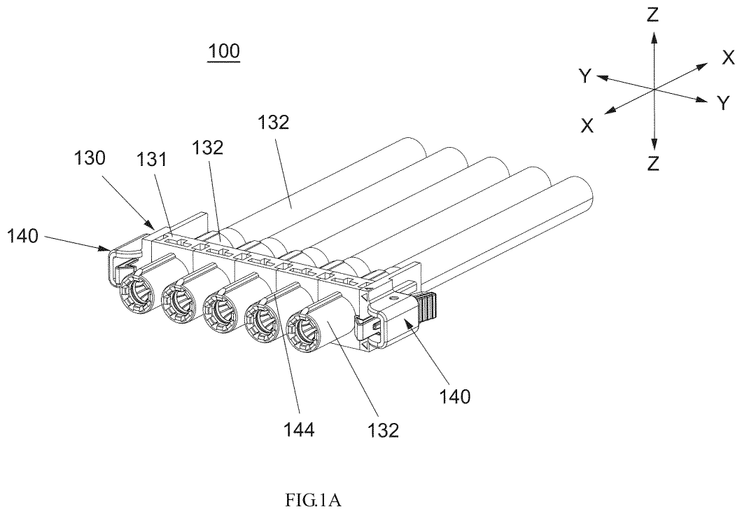

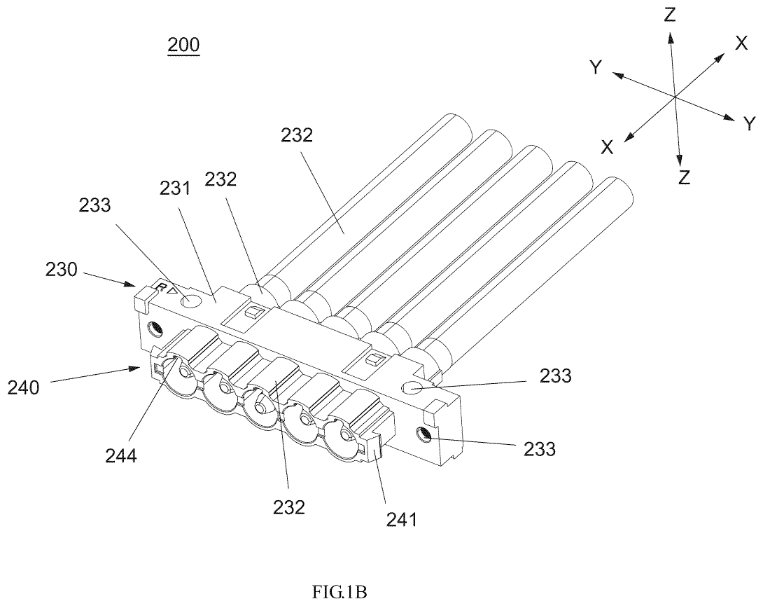

As shown in FIGS. 1A and 1B, the electrical connector may include an insulating housing, a securing structure, and a plurality of mating contacts. The insulating housing of the electrical connector may include an insulating housing main body and a plurality of insulating tubular members. The plurality of insulating tubular members of the electrical connector may be configured to protrude from the insulating housing main body of the electrical connector, and the plurality of insulating tubular members of the electrical connector may be arranged in one or more rows on the insulating housing main body, with each row of the insulating tubular members constituting an insulating tubular members group. A securing structure of the electrical connector may be disposed on at least one end of at least one end of the electrical connector, e.g., at least one end of the insulating tubular members groups, in an extending direction thereof. Each of the plurality of mating contacts is accommodated in each insulating tubular member, and the mating contacts are configured to electrically connect with the complementary members. In some exemplary embodiments, the plurality of insulating tubular members may have a cylindrical shape. As shown in FIG. 1A, the plurality of insulating tubular members extend along a lengthwise direction X of the electrical connector, and the plurality of insulating tubular members are arranged in one or more rows (as illustrated in FIG. 12) in a direction Z perpendicular to the lengthwise direction X along the electrical connector.

With the electrical connector of the present application, the plurality of insulating tubular members are configured to protrude from the insulating housing main body and the plurality of mating contacts each are accommodated in each of the insulating tubular members, such that mating contacts each are physically separated from each other by the insulating housing main body and electrically isolated from each other by the insulating tubular members. The insulating housing main body allows securing the insulating tubular members at intervals, which ensures that the mating contacts accommodated in the insulating tubular members are secured to each other in a manner that they are spaced apart from each other, thereby realizing reliability in terms of mechanical and electrical connections.

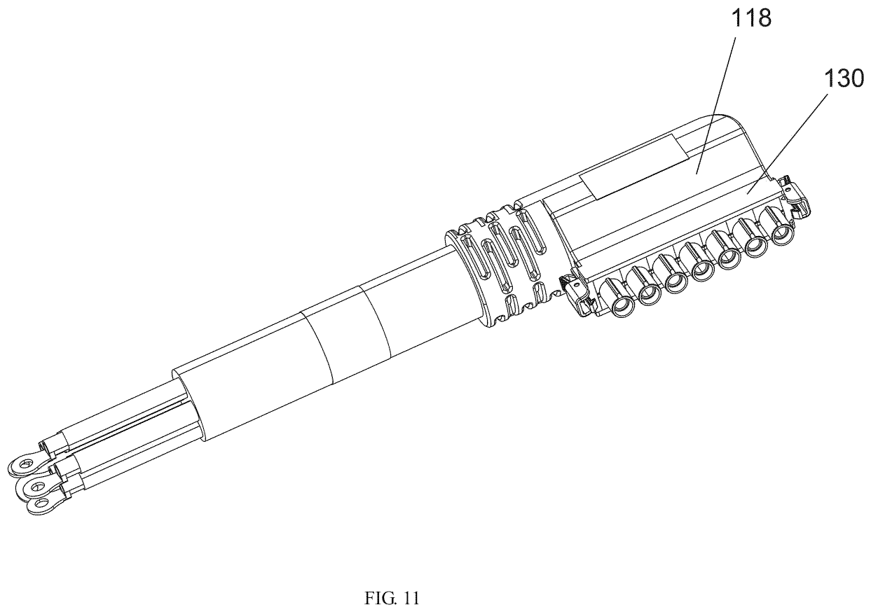

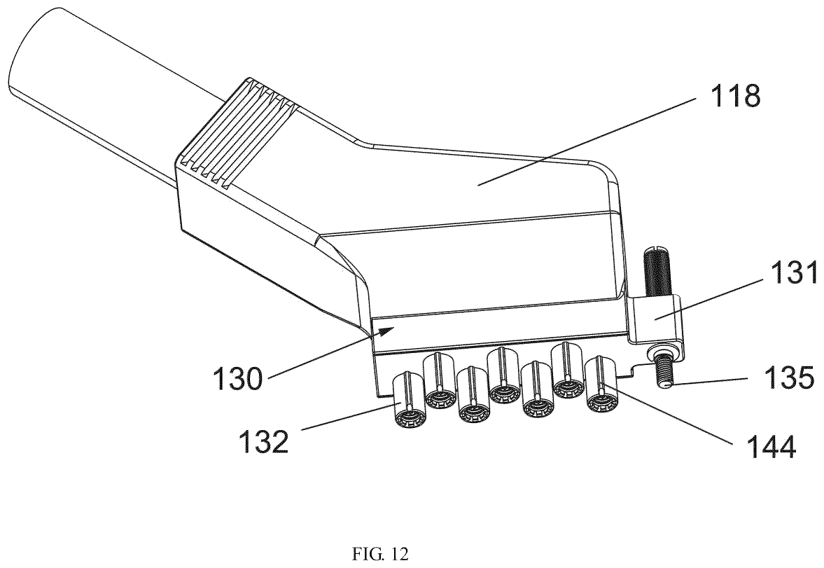

The electrical connector of the present application may be a receptacle connector or a plug connector. Details of the electrical connector of the present application are described in detail below in conjunction with FIGS. 1A through 12.

A receptacle connector as an electrical connector of the present application is first described in conjunction with FIG. 1A and FIGS. 2A through 5B.

As shown in FIG. 1A, the electrical connector may be a receptacle connector 100. As shown in FIG. 1A, the receptacle connector 100 may include an insulating housing 130, and the insulating housing 130 may include an insulating housing main body 131 and a plurality of insulating tubular members 132. The plurality of insulating tubular members 132 of the insulating housing 130 may be configured to protrude from the insulating housing main body 131, and the plurality of insulating tubular members 132 of the insulating housing 130 may be arranged in one or more rows on the insulating housing main body 131, with each row of the insulating tubular members 132 constituting an insulating tubular members group. As shown in FIG. 1A, the plurality of insulating tubular members 132 of the insulating housing 130 may be arranged in one row on the insulating housing main body 131. In some alternative embodiments, the plurality of insulating tubular members 132 of the insulating housing 130 may be arranged in two rows on the insulating housing main body 131, as shown in FIG. 12. However, the embodiments of the present application are not limited thereto, and the plurality of insulating tubular members 132 of the insulating housing 130 may be arranged in three or more rows on the insulating housing main body 131.

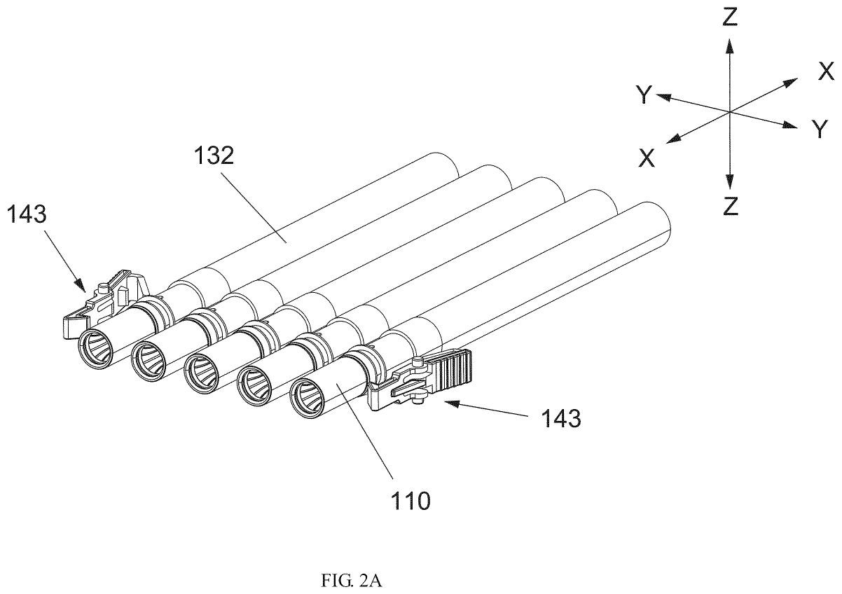

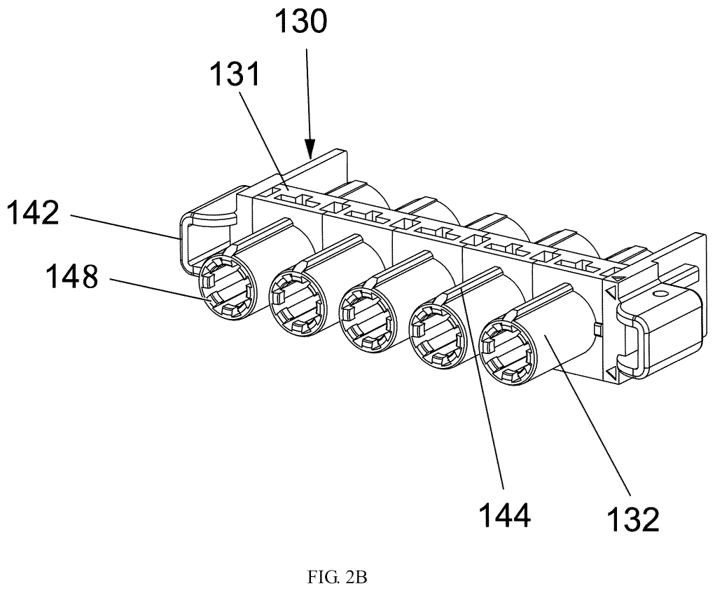

As shown in FIG. 1A, the securing structure 140 of the receptacle connector 100 may be disposed on at least one end of at least one of the insulating tubular members groups in an extending direction thereof. As shown in FIGS. 2A and 2B, a plurality of mating contacts 110 of the receptacle connector 100 may be accommodated in each insulating tubular member 132.

As clearly illustrated in FIG. 2B, a plurality of protruding portions 148 may be disposed at openings of the plurality of insulating tubular members 132 of the insulating housing 130 that accommodate the mating contacts 110. In some embodiments, the plurality of protruding portions 148 are disposed on an inner surface of the openings of the plurality of insulating tubular members 132. The plurality of mating contacts 110 of the receptacle connector 100 may be accommodated in each of the insulating tubular members 132 and located within the plurality of protruding portions 148. The plurality of protruding portions 148 disposed in the openings of the insulating tubular members 132 can prevent accidental contact with the mating contacts 110 of the receptacle connector, thereby providing effective protection for the mating components of the receptacle connector.

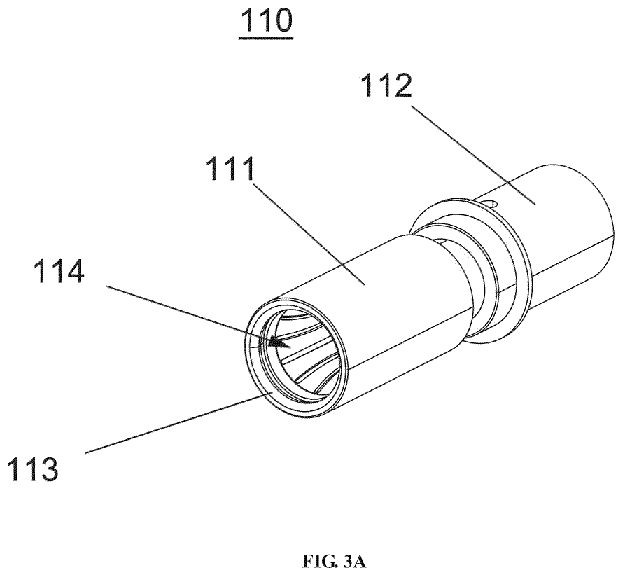

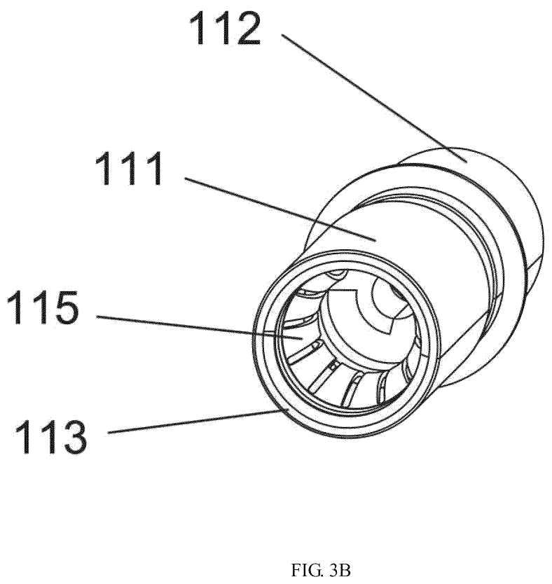

Referring next to FIG. 3A, the mating contact 110 of the receptacle connector 100 may include a mating component 111 and a tail component 112. The mating component 111 of the mating contact 110 may include, on one end of the mating component, a cup-shaped metal structural member 113 and a metal elastic deformation member 114 mounted on the metal structural member 113. When a complementary member (e.g., a mating contact of a plug connector) is inserted within the metal structural member 113, the metal elastic deformation member 114 is deformed by being squeezed by the complementary member. As shown in FIG. 3A, in some exemplary embodiments, the tail component 112 of the mating contact 110 may be disposed on the other end of the mating component 111, and the tail component 112 of the mating contact 110 may extend along a plugging and unplugging direction X.

In some embodiments, as shown in FIGS. 1A and 2A, the mating contact 110 of the receptacle connector 100 according to the present application may have the same structure, thereby enabling easy insertion of one or more mating contacts. It is understood that the mating contacts 110 of the receptacle connector 100 according to the present application may have different structures, and the present application does not limit this.

In the case where the electrical connector of the present application is a receptacle connector, the mating component may comprise, on one end of the mating component, a cup-shaped metal structural member and a metal elastic deformation member mounted on the metal structural member, and the metal elastic deformation member is deformed by being squeezed by a complementary member when the complementary member is inserted in the metal structural member. Therefore, the metal elastic deformation member will generate a counter-acting force inwardly along a radial direction of the insulating tubular member on an inserted complementary member (e.g., a mating contact of a plug connector), which further retains the complementary member (e.g., a mating contact of a plug connector) firmly inside the mating component, thus ensuring a high degree of reliability of the electrical connector in terms of mechanical and electrical connections. In particular, the electrical connector of the present application is suitable to be used as an electrical connector for AC power connections, and can ensure a high degree of reliability and stability of the electrical and mechanical connections between the mating contact of the receptacle connector and the complementary member (e.g., a mating contact of a plug connector), even in the case of heavy cables, inadvertent pulling or frequent unplugging and plugging, and the like.

In some exemplary embodiments, as shown in FIGS. 3A and 3B, the metal elastic deformation member 114 may comprise at least one deformation portion 115 extending from an inner peripheral wall of the metal structural member 113 to a center of the metal structural member 113, the deformation portion 115 being deformed by being squeezed by a complementary member (e.g., a mating contact of a plug connector) when the complementary member is inserted into the metal structural member 113.

In the case where the electrical connector of the present application is a receptacle connector, the metal elastic deformation member may comprise at least one deformation portion extending from an inner peripheral wall of the metal structural member to a center of the metal structural member, and the deformation portion is deformed by being squeezed by a complementary member (e.g., a mating contact of a plug connector) when the complementary member is inserted in the metal structural member. Such a configuration enables a greater retention force to be generated for the complementary member inserted into the metal structural member, and thus enables the complementary member to be more firmly retained inside the mating component, thereby further providing more secure and reliable mechanical and electrical connections. In particular, the configuration where the electrical connector of the present application has a metal elastic deformation member can be reliably and stably adapted to electrically connect for an AC of 50 A to 70 A (e.g., 60 A).

In some exemplary embodiments, as shown in FIGS. 3A and 3B, the deformation portion 115 is a plurality of tabs curved toward an interior of the metal structural member 113, the plurality of tabs being formed by cutting the metal elastic deformation member 114.

Where the electrical connector of the present application is a receptacle connector, the deformation portion is configured as a plurality of tabs curved towards an interior of the metal structural member. On the one hand, the plurality of tabs can provide a compliant force to allow smooth insertion of a complementary member (e.g., a mating contact of a plug connector) when the complementary member is inserted into the metal structural member, so as to enable the complementary member to be inserted more smoothly into the metal structural member and precisely aligned. On the other hand, the plurality of tabs can provide a strong retention force on an inserted complementary member after the complementary member is smoothly inserted into the metal structural member, which in turn firmly retains the complementary member inside the mating component, and can ensure stability and reliability of the electrical and mechanical connections between the complementary member and the mating contact of the receptacle connector, even in the case of heavy cables, inadvertent pulling or frequent unplugging and plugging, and the like.

In some exemplary embodiments, although not shown in the accompanying drawings, the metal elastic deformation member 114 may also be formed as a strip capable of being bent and inserted into the metal structural member 113, the strip being retained on the metal structural member 113 by means of the insulating housing 130. However, the embodiments of the present application are not limited thereto, as long as the metal elastic deformation member 114 is capable of providing an appropriate retention force for the inserted complementary member.

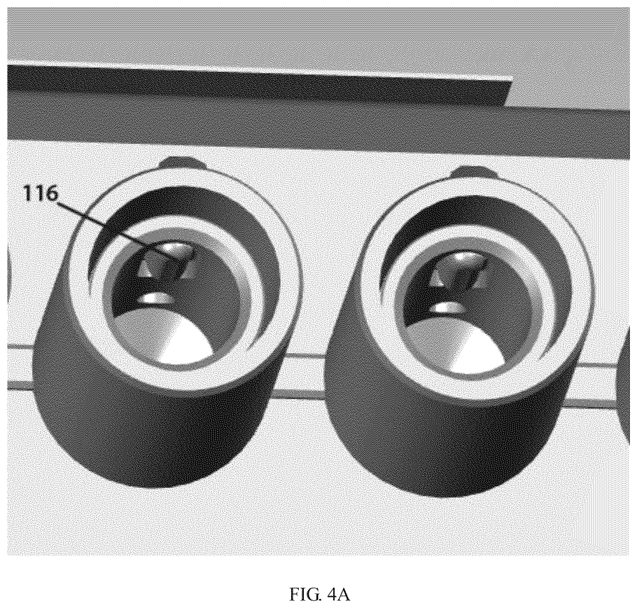

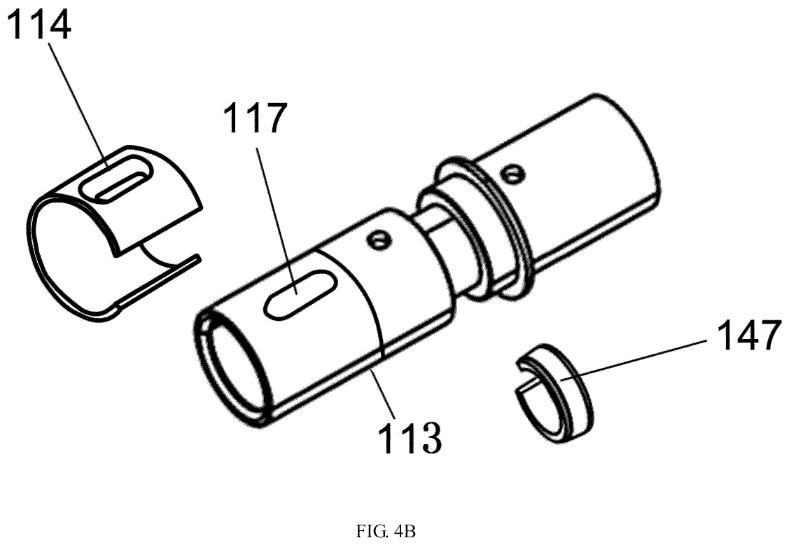

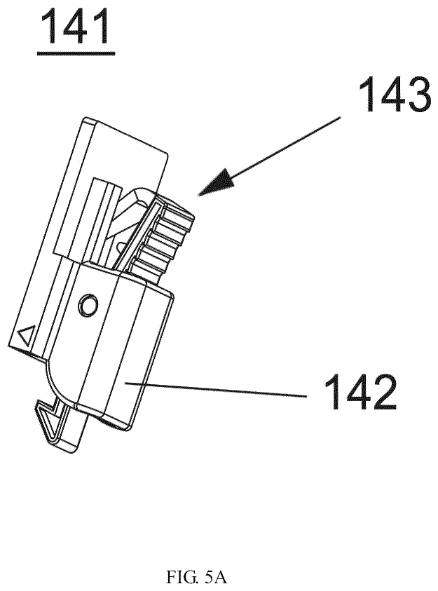

As shown in FIGS. 4A and 4B, in some exemplary embodiments, the deformation portion 115 may also be a protrusion 116 disposed on the metal elastic deformation member 114. Although one protrusion 116 is shown disposed on the metal elastic deformation member 114 in FIGS. 4A and 4B, in other embodiments, two or more protrusions may also be disposed on the metal elastic deformation member 114, and the present application does not limit this.

In the case where the electrical connector of the present application is a receptacle connector, the deformation portion may be a protrusion disposed on the metal elastic deformation member. The protrusion is subjected to a force by being squeezed by a complementary member (e.g., a mating contact of a plug connector) when the complementary member is inserted into the metal structural member, which further causes the metal elastic deformation member to deform elastically and thus generate a counter-acting force inwardly along a radial direction of the insulating tubular member on the complementary member inserted into the metal structural member. Therefore, the complementary member can be more firmly retained within the mating component, thereby further providing more secure mechanical and electrical connections.

In some exemplary embodiments, as shown in FIGS. 4A and 4B, the metal elastic deformation member 114 may be formed to enclose at least a portion of the metal structural member 113. In some exemplary embodiments, a peripheral wall of the metal structural member 113 may be disposed with an opening 117 through which the protrusion 116 protrudes into an interior of the metal structural member 113. In some embodiments, the mating contact 110 may also include a securing member 147 (as illustrated in FIG. 4B) disposed between the mating component 111 and the tail component 112 for securing the mating contact 110 into the insulating housing 130. In some embodiments, the securing member 147 may have a ring shape or a C-shaped shape, and embodiments of the present application are not limited thereto.

In some exemplary embodiments, the protrusion 116 may be a rib, not shown, formed on the metal elastic deformation member 114. It should be understood that one or more ribs may be disposed on the metal elastic deformation member 114, and the present application is not limited thereto. In some exemplary embodiments, the protrusion 116 is a rib formed on the metal elastic deformation member 114 by an embossing process.

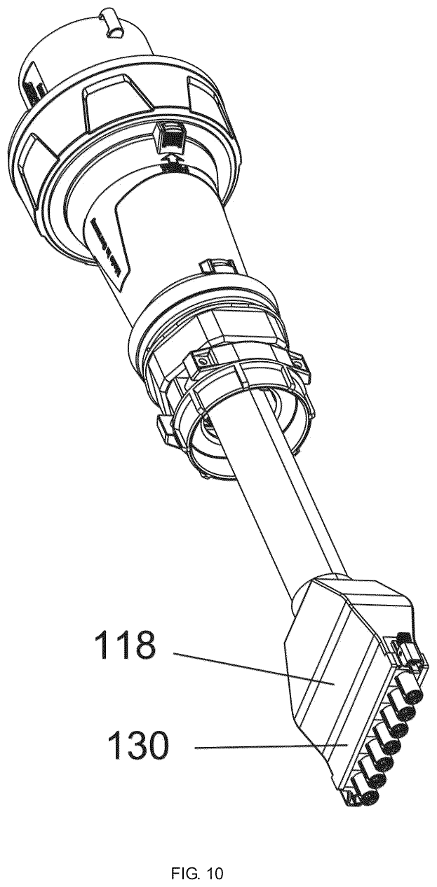

In some exemplary embodiments, the tail component 112 is configured to receive a cable or be mounted to a printed circuit board. In some exemplary embodiments, as shown in FIGS. 10 to 12, in the event that the tail component 112 is configured to receive a cable, the electrical connector further has an overmolding member 118 partially molded onto the cable and partially molded onto the insulating housing 130 to hold the received cable.

In the case where the electrical connector of the present application is a receptacle connector, the receptacle connector may comprise an overmolding member 118 partially molded onto the cable and partially molded onto the insulating housing to hold the received cable, and thus it is possible to mold the tail component of the mating contacts of the electrical connector into a desired shape. In some embodiments, the tail component molding may be made by injection molding using a plastic material, which allows the tail component of the mating contacts to be easily molded into the desired shape due to the flexibility of the injection molding process for plastic members.

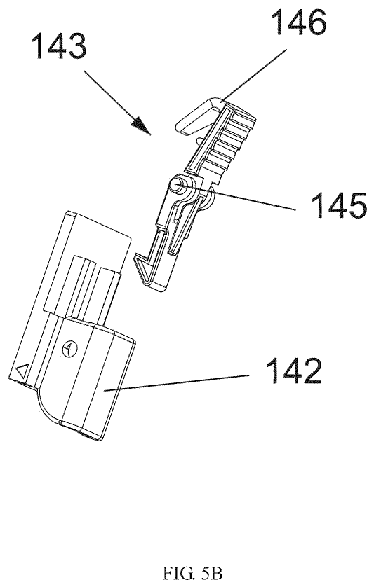

In some exemplary embodiments, as shown in FIGS. 5A and 5B, the securing structure 140 may include a latching mechanism 141 mounted to the insulating housing 130. In some optional embodiments, the securing structure 140 may include a latch fastener formed on the insulating housing 130. As shown in FIGS. 5A and 5B, in some exemplary embodiments, the latching mechanism 141 includes an outer shell 142 and a latch 143 capable of being pivotally mounted within the outer shell 142. As shown in FIG. 5B, the latch 143 may have a flexible arm 145, such that the latch 143 is easily inserted into the outer shell 142 by having the flexible arm 145, thereby forming the latching mechanism 141. As shown in FIG. 5B, the latching mechanism 141 may have an integrated elastic beam 146 to place the latch 143 in a locked position. The latch 143 of the present application may have a single-piece structure, thereby simplifying the manufacture of the connector. However, the present application is not limited to the latch 143 having a single-piece structure.

In the case where the electrical connector of the present application is a receptacle connector, the securing structure may comprise a latching mechanism. The latch is able to put the electrical connector (e.g., a receptacle connector and a plug connector mating with each other) in a locked state or in an unlocked state. With the electrical connector of the present application, the provision of the latching mechanism is capable of ensuring the reliability of the electrical connector in terms of mechanical and electrical connections while allowing an operator to quickly lock and unlock the electrical connector. The electrical connector may include a latching mechanism disposed on at least one end of the at least one of the insulating tubular members groups in an extending direction thereof, thereby allowing an operator to quickly lock and unlock the electrical connector even when space is limited.

In some exemplary embodiments, the securing structure 140 may be a nut or a screw 135 mounted on the insulating housing 130, as illustrated in FIG. 12. In some exemplary embodiments, the insulating housing 130 includes a flange having a through-hole. In some exemplary embodiments, a threaded connecting member may be inserted into the through-hole to connect the electrical connector to a printed circuit board, as shown in FIG. 12. In some exemplary embodiments, the threaded connecting member may be inserted into the through-hole to connect the electrical connector to the mating connector.

In some exemplary embodiments, a guiding projection 144 is disposed on an outer peripheral surface of the insulating tubular member 132 along a plugging and unplugging direction. In the case where the electrical connector of the present application is a receptacle connector, a guiding projection 144 is disposed on an outer peripheral surface of the insulating tubular member along a plugging and unplugging direction, for cooperating with the guiding recess of a mating plug connector (as shown by reference sign 244 hereinafter below), such that the receptacle connector can be precisely aligned with the mating plug connector, preventing misalignment between the receptacle connector and the plug connector due to improper insertion caused by, for example, skewing of the insertion direction, or the like.

Next, a plug connector as an electrical connector of the present application is first described in connection with FIGS. 1B and 6A to 9C.

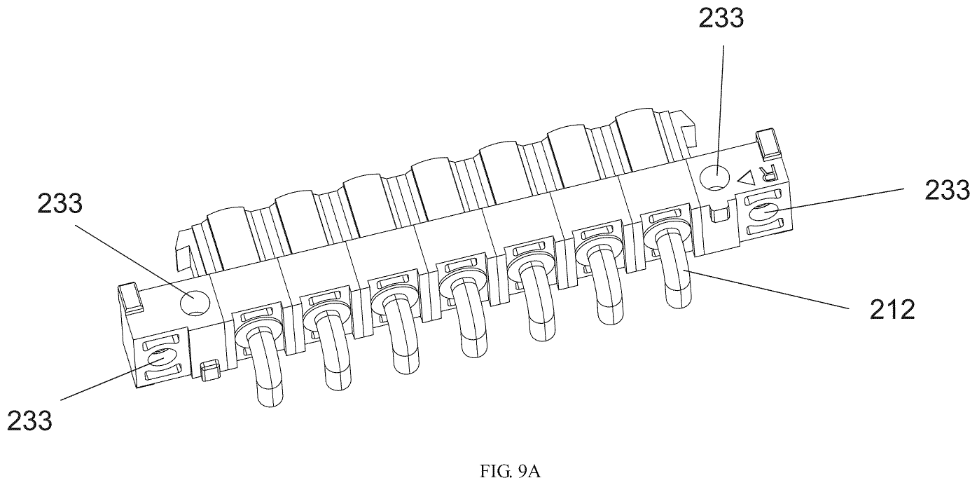

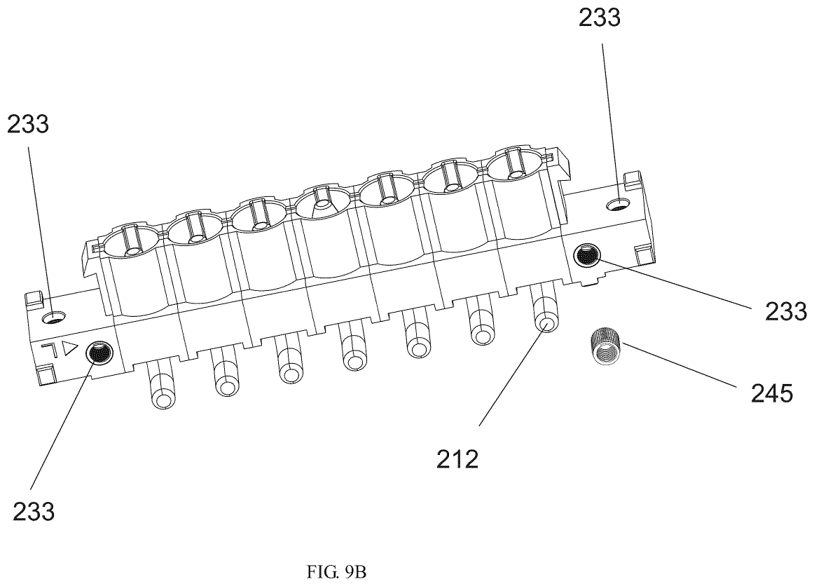

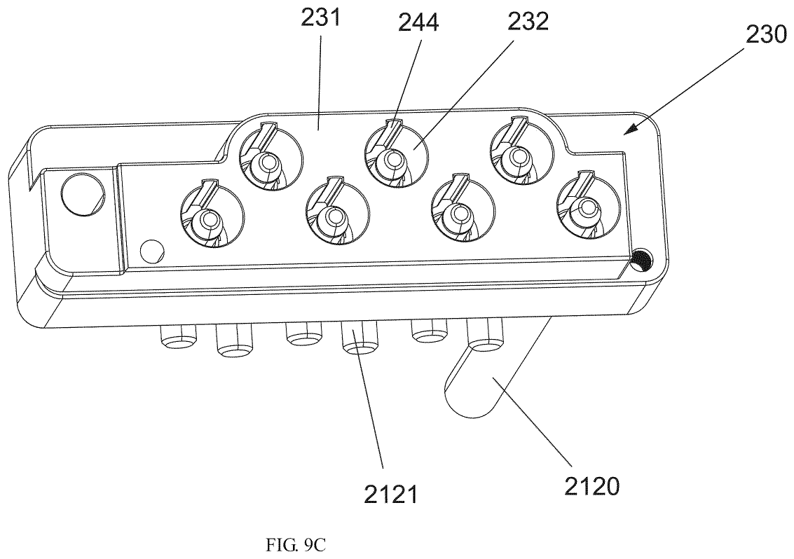

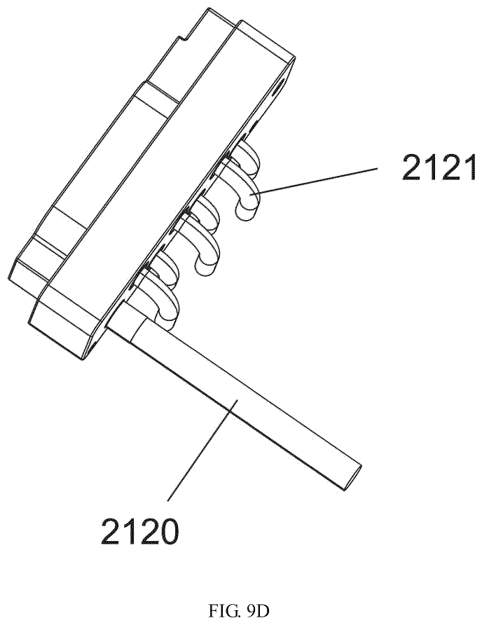

In some exemplary embodiments, the electrical connector according to the present application may be a plug connector 200. As shown in FIG. 1B, the plug connector 200 may include an insulating housing 230, and the insulating housing 230 may include an insulating housing main body 231 and a plurality of insulating tubular members 232. The plurality of insulating tubular members 232 of the insulating housing 230 may be configured to protrude from the insulating housing main body 231, and the plurality of insulating tubular members 232 of the insulating housing 230 are arranged in one or more rows on the insulating housing main body 231, with each row of the insulating tubular members 232 constituting an insulating tubular members group. As shown in FIG. 1B, the plurality of insulating tubular members 232 of the insulating housing 230 may be arranged in one row on the insulating housing main body 231. In some alternative embodiments, the plurality of insulating tubular members 232 of the insulating housing 230 may be arranged in two rows on the insulating housing main body 231, as shown in FIG. 9C. However, the embodiments of the present application are not limited thereto, and the plurality of insulating tubular members 232 of the insulating housing 230 may be arranged in three or more rows on the insulating housing main body 231, depending on the actual needs of the product.

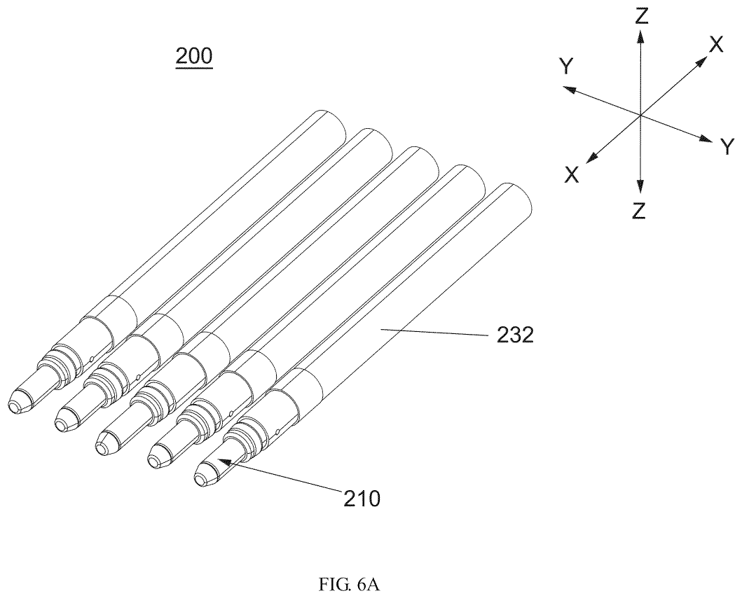

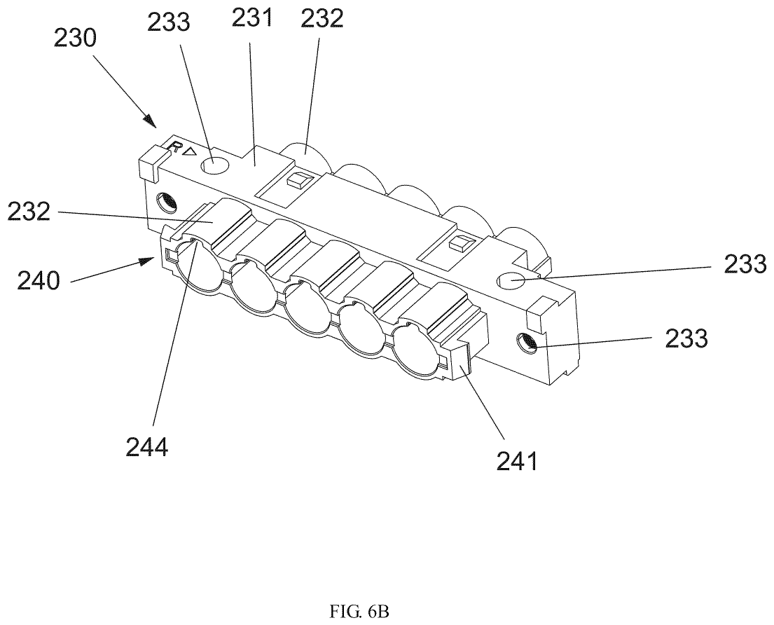

As shown in FIG. 1B, the securing structure 240 of the plug connector 200 may be disposed on at least one end of at least one of the plug connector 200, e.g., on at least one end of the insulating tubular members groups in an extending direction thereof. As shown in FIGS. 6A and 6B, a plurality of mating contacts 210 of the plug connector 200 may be accommodated in each insulating tubular member 232.

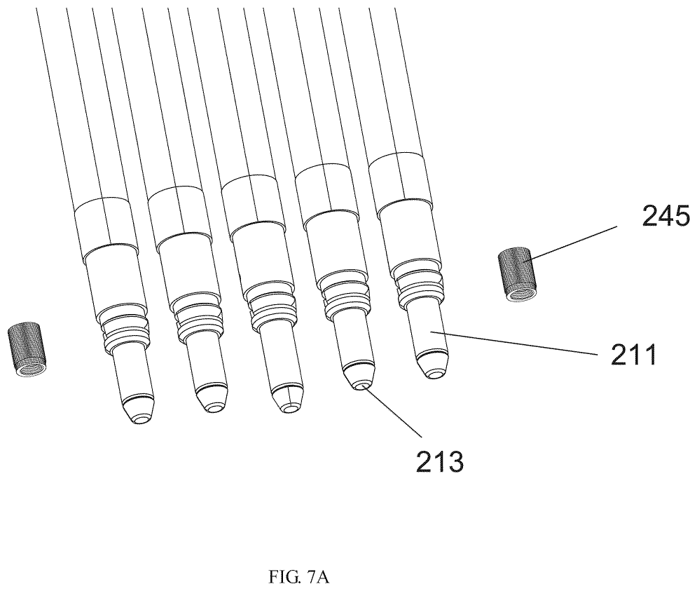

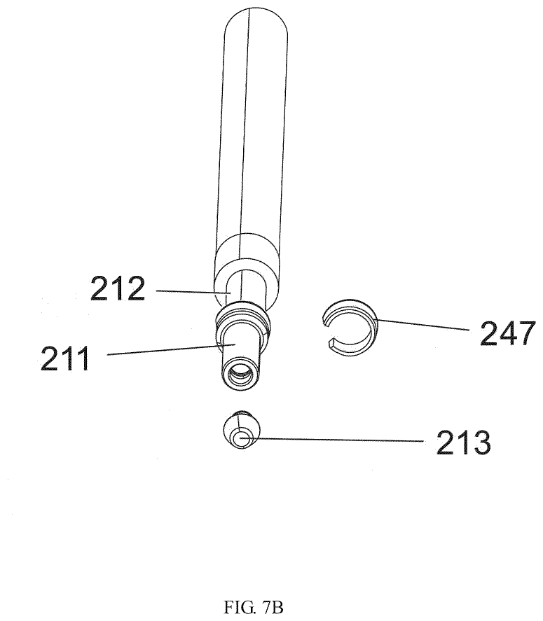

Continuing as shown in FIG. 7B, the mating contact 210 of the plug connector 200 may include a mating component 211 and a tail component 212, and the mating component 211 may include an elongated metal structural member. In some embodiments, the mating contact 210 may also include a securing member 247 (as illustrated in FIG. 7B) disposed between the mating component 211 and the tail component 212 for securing the mating contact 210 into the insulating housing 230. In some embodiments, the securing member 247 may have a ring shape or a C-shaped shape, and embodiments of the present application are not limited thereto.

In some embodiments, the mating contact 210 of the plug connector 200 according to the present application may have the same structure, thereby enabling easy insertion of one or more mating contacts. It is understood that the mating contact 210 of the plug connector 200 according to the present application may have a different structure (as will be described below), and the present application does not limit this.

In some exemplary embodiments, as clearly illustrated in FIG. 7B, the mating component 211 may be a tubular member, and the mating component 211 may have an insulating cover member 213 on one end of the mating component 211. The insulating cover member 213 is sized to be suitable for covering an end of an elongated metal structural member. The tail component 212 may extend from the other end of the mating component 211, as shown in FIG. 7A. With the plug connector of the present application, the mating component of the plug connector may have an insulating cover member on one end of the mating component, which can prevent accidental contact with the elongate metal structural member of the mating component, thereby providing effective protection of the elongate metal structural member of the mating component.

In some exemplary embodiments, as shown in FIG. 7A, one or more of the plurality of mating components 211 (e.g., the mating component located in the middle) has a longer length than other mating components of the plurality of mating components 211. In a plug connector according to the present application, one or more of the plurality of mating components may have a length longer than those of the other mating components for specially designed uses. For example, in some embodiments, the longer mating component may be used for a grounding component or a neutral wire.

In some other exemplary embodiments, the tail component 212 may be configured to receive a cable or be mounted to a printed circuit board. In some other exemplary embodiments, in the event that the tail component 212 is configured to receive a cable, the plug connector also has an overmolding member partially molded onto the cable and partially molded onto the insulating housing 230 to hold the received cable.

In the case where the electrical connector of the present application is a plug connector, the plug connector may comprise an overmolding member partially molded onto the cable and partially molded onto the insulating housing to hold the received cable, and thus it is possible to mold the tail component of the mating contacts of the electrical connector into a desired shape according to the needs of the connection. In some embodiments, the tail component molding may be made by injection molding using a plastic material, which allows the tail component of the mating contacts to be easily molded into the desired shape due to the flexibility of the injection molding process for plastic members.

In some other exemplary embodiments, the securing structure 240 may include a latch fastener 241 formed on the insulating housing 230. As shown in FIG. 6B, the plug connector 200 has a latch fastener 241 that latches with a latching mechanism 141 (as described above in conjunction with FIGS. 5A and 5B) on the insulating housing 130 of the receptacle connector.

In some other exemplary embodiments, the securing structure 240 of the plug electrical connector may include a latching mechanism mounted to the insulating housing 230, and the latching mechanism may include an outer shell and a latch capable of being pivotally mounted within the outer shell. Although not shown in the accompanying drawings, it should be understood that in optional embodiments, the securing structure 240 of the plug electrical connector may be disposed with a latch as described above in conjunction with FIGS. 5A and 5B.

In the case where the securing structure 240 of the plug electrical connector includes a latch (as illustrated by reference sign 141 in FIG. 5A and FIG. 5B), the securing structure 140 of the receptacle electrical connector may include a latch fastener (as illustrated by reference sign 241 in FIG. 6B) that latches with the latching mechanism on the insulating housing 130 of the plug connector.

With the plug connector of the present application, the securing structure may comprise a latching mechanism mounted to the insulating housing or a latch fastener formed on the insulating housing, such that the electrical connector can be put in a locked state or an unlocked state. With the electrical connector of the present application, the provision of the latching mechanism or a latch fastener is capable of ensuring the reliability of the electrical connectors mating with each other in terms of mechanical and electrical connections while allowing an operator to quickly lock and unlock the electrical connectors mating with each other. The electrical connector includes a latching mechanism or a latch fastener disposed on at least one end of the at least one of the insulating tubular members groups in an extending direction thereof, thereby allowing and facilitating an operator to quickly lock and unlock the electrical connector even when operating space is limited.

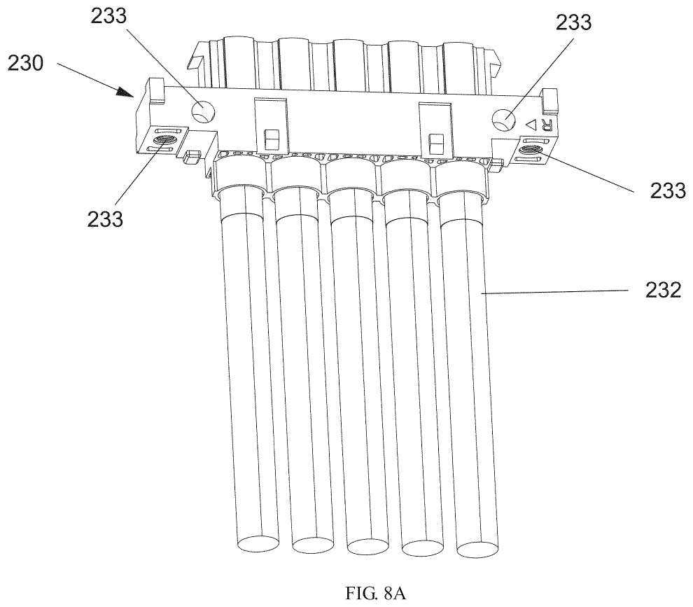

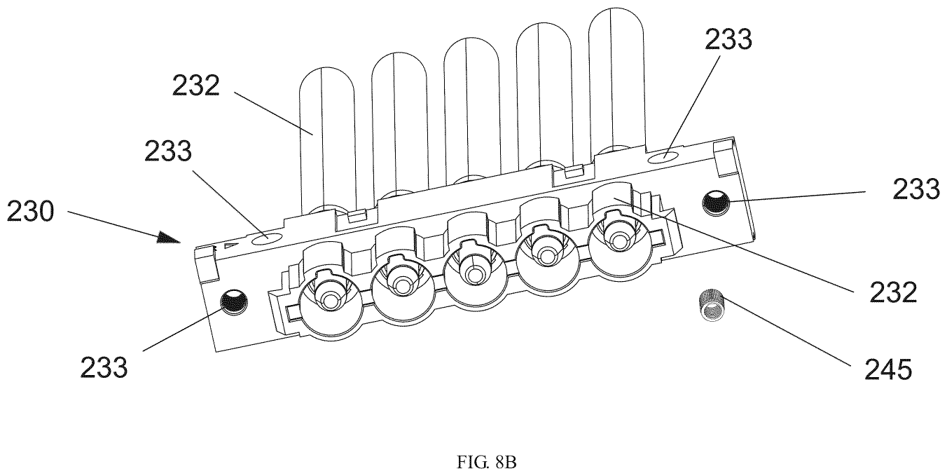

In some other exemplary embodiments, the securing structure 240 may be a nut or a screw mounted to the insulating housing 230. In some other exemplary embodiments, the insulating housing 230 includes a flange having a through-hole 233, as illustrated in FIGS. 8A and 8B. In some other exemplary embodiments, as shown in FIG. 8A and FIG. 8B, a threaded connecting member 245 is inserted into the through-hole 233 to connect the electrical connector to the printed circuit board.

The mating end of the electrical connector of the present application can be used to connect both a printed circuit board and a cable, so the electrical connector of the present application has a very wide range of applications and good compatibility. In some embodiments, to accommodate mounting the electrical connector to a circuit board in different ways, the threaded connecting member 245 can be inserted into through-holes on different surfaces of the electrical connector (as illustrated in FIGS. 8A and 8B). In exemplary embodiments of the present application, the tail component 212 of the mating contact of the electrical connector mounted to the circuit board may be configured to be soldered in a hole of the printed circuit board, as shown in FIGS. 9A to 9B. As shown in FIGS. 9A to 9B, the tail component of the mating contact of the electrical connector is configured to form a 90-degree bend with respect to the plugging and unplugging direction. However, the tail component of the mating contact of the electrical connector may also be of other shapes, e.g., forming a bend of 60 degrees to 90 degrees, e.g., 60 degrees, 70 degrees, or 80 degrees, with respect to the plugging and unplugging direction for attachment to the printed circuit board or the cable.

In order to make the electrical connector of the present application suitable for attachment to a cable or mounting to a circuit board, the tail end of the electrical connector of the present application may be manufactured in different shapes. As illustrated as described in FIGS. 10 to 12, differently shaped tail ends of the electrical connector may provide better support for the connected cables, and the tail ends of the electrical connector may be molded to form an overmolding member to guide the cables in a particular direction. In other examples, some of the mating contacts of the connector configured for mounting to a circuit board may be terminated to a cable to produce a hybrid connector. As illustrated in FIGS. 9C and 9D, the tail component of the mating contact of the electrical connector includes a straight tail component 2120 that is parallel to the plugging and unplugging direction and also includes a curved tail component 2121 that is bent at 90 degrees with respect to the plugging and unplugging direction, thereby forming a hybrid connector, such that some of the mating contacts in the electrical connector configured for mounting to a circuit board may be terminated to a cable. The material of the overmolding member may be the same or different from the material of the insulating housing of the electrical connector. The overmolding member may be more flexible. For example, it may be made of rubber or silicone.

In some other exemplary embodiments, as shown in FIGS. 9A and 9B, the threaded connecting member 245 may be inserted into the through-hole 233 to connect the electrical connector to the mating connector. In some other exemplary embodiments, as illustrated in FIG. 9C, a guiding recess 244 may be disposed on an inner peripheral surface of the insulating tubular member 232 along a plugging and unplugging direction.

In the case where the electrical connector of the present application is a plug connector, a guiding recess 244 is disposed on an inner peripheral surface of the insulating tubular member along a plugging and unplugging direction, for cooperating with the guiding projection of the mating receptacle connector (as shown above by reference sign 144), such that the plug connector can be precisely aligned with the mating receptacle connector, preventing misalignment between the plug connector and the receptacle connector due to improper insertion caused by, for example, skewing of the insertion direction, or the like.

According to a second aspect of the present application there is also provided an electrical connector assembly, wherein the electrical connector assembly may comprise a receptacle connector 100 and a plug connector 200 disposed in pairs, the receptacle connector 100 being a receptacle connector 100 according to some embodiments of the first aspect of the present application, and the plug connector 200 being a plug connector according to other embodiments of the first aspect of the present application.

With the electrical connector assembly of the present application, the plurality of insulating tubular members of the receptacle connector 100 and the plug connector 200 disposed in pairs are configured to protrude from the insulating housing main body and the plurality of mating contacts each are accommodated in each of the insulating tubular members, such that mating contacts each are physically separated from each other by the insulating housing main body and electrically isolated from each other by the insulating tubular members. The insulating housing main body allows to secure the insulating tubular members at intervals, which ensures that the mating contacts accommodated in the insulating tubular members are secured to each other in a manner that they are spaced apart from each other, thereby realizing reliability in terms of mechanical and electrical connections.

The assembly process of the electrical connector assembly is described below with reference to FIGS. 1A and 1B. The plug connector 200 is inserted into the receptacle connector 100 along a plugging and unplugging direction by means of a robot or manually, and then a latch on the insulating housing of the receptacle connector 100 is cooperated with a latch fastener on the insulating housing of the plug connector by means of a robot or manually for locking, such that the receptacle connector 100 and the plug connector 200 form reliable and stable mechanical and electrical connections.

In the assembly process of the electrical connector assembly of the present application, a guiding projection 144 is disposed on an outer peripheral surface of the insulating tubular member of a receptacle connector 100, and a guiding recess 244 is disposed on an inner peripheral surface of the insulating tubular member of a plug connector 200, such that the mating contacts of the plug connector 200 and the receptacle connector 100 are precisely aligned. Moreover, the metal elastic deformation member disposed on the receptacle connector 100 is deformed by being squeezed by a mating contact of a plug connector when the mating contact of the plug connector is inserted in the metal structural member, such that the metal elastic deformation member will generate a counter-acting force inwardly along a radial direction of the insulating tubular member on an inserted mating contact of the plug connector, which further retains the mating contact of the plug connector firmly inside the mating component of the receptacle connector 100, thus ensuring a high degree of reliability of the electrical connector in terms of mechanical and electrical connections. In particular, the electrical connector of the present application is suitable to be used as an electrical connector for AC power connections, and can ensure a high degree of reliability and stability of the electrical and mechanical connections between the mating contact of the receptacle connector and the mating contact of the plug connector, even in the case of heavy cables, inadvertent pulling or frequent unplugging and plugging, and the like.

The present disclosure has been described by the above embodiments, but it should be understood that a variety of variations, modifications and improvements may be made according to the teaching of the present disclosure by those skilled in the art, and all of these variations, modifications and improvements fall within the spirit and the scope of protection of the present disclosure. The scope of protection of the present disclosure is defined by the appended claims and its equivalent scope. The above embodiments are only for the purpose of illustration and description, and are not intended to limit the present disclosure to the scope of the described embodiments.

Moreover, although many creative aspects of the electronic system have been described above with reference to a board connector and a cable connector, it should be understood that the aspects of the present disclosure are not limited to these. Any one of the creative features, whether alone or combined with one or more other creative features, can also be used for two mating cable connectors or two mating board connectors. Also, the connector can be used as a plug connector or a socket connector. The connector may be an orthogonal connector, a vertical connector, a coplanar connector, or a right-angle connector.

In the description of the present disclosure, it is to be understood that orientation or positional relationships indicated by orientation words “front’, “rear”, “upper”, “lower”, “left”, “right”, “lateral direction”, “mating direction”, “perpendicular direction”, “perpendicular”, “horizontal”, “top”, “bottom” and the like usually are shown based on the accompanying drawings, only for the purposes of the ease in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features”. Thus, the exemplary term “above” can encompass both the orientations of “above” and “below”. In addition, these components or features may be otherwise oriented (for example rotated by 90 degrees or other angles) and the present disclosure is intended to include all these cases.

It should be noted that the terms used herein are only for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

It should be noted that the terms “first”, “second” and the like in the description and claims, as well as the above accompanying drawings, of the present disclosure are used to distinguish similar objects, but not necessarily used to describe a specific order or precedence order. It should be understood that ordinal numbers used in this way can be interchanged as appropriate, so that the embodiments of the present disclosure described herein can be implemented in a sequence other than those illustrated or described herein.

What is claimed is:

1.-12. (canceled)

13. A receptacle electrical connector, comprising:
an insulating housing comprising an insulating housing main body and a plurality of insulating tubular members protruding from the insulating housing main body, the plurality of insulating tubular members being arranged in a single row, wherein a quantity of the plurality of insulating tubular members arranged in the single row is seven, wherein at least one insulating tubular member of the plurality of insulating tubular members has a guiding projection extending along a plugging and unplugging direction of the receptacle electrical connector at an outer surface of the at least one insulating tubular member;
a plurality of mating contacts disposed in respective insulating tubular members of the plurality of insulating tubular members, wherein each of the plurality of mating contacts comprises a cup-shaped metal structural member; and
at least one securing structure disposed on at least one end of the insulating housing, wherein the at least one securing structure comprises a first latch at a first end of the insulating housing.

14. The receptacle electrical connector of claim 13, wherein the cup-shaped metal structural member comprises a plurality of protrusions at an inside surface of the cup-shaped metal structural member.

15. The receptacle electrical connector of claim 13, wherein the at least one securing structure further comprises a second latch at a second end of the insulating housing.

16. The receptacle electrical connector of claim 13, wherein the guiding projection extends from an outside of an insulating tubular member in a direction perpendicular to a row direction in which the plurality of insulating tubular members are arranged.

17. A plug electrical connector, comprising:
an insulating housing comprising a plurality of insulating tubular members, the plurality of insulating tubular members being arranged in a row, wherein a quantity of the plurality of insulating tubular members arranged in the row is seven, and wherein at least one insulating tubular member of the plurality of insulating tubular members has a guiding recess extending along a plugging and unplugging direction of the plug electrical connector at an inner surface of the at least one insulating tubular member;
a plurality of mating contacts disposed in respective insulating tubular members of the plurality of insulating tubular members, wherein each mating contact of the plurality of mating contacts comprises an elongate metal structural member; and
at least one securing structure disposed on at least one end of the insulating housing,
wherein each mating contact of the plurality of mating contacts comprises an insulating cover member at an end of the mating contact.

18. The plug electrical connector of claim 17, wherein the plurality of mating contacts include a plurality of mating components that include tubular members.

19. The plug electrical connector of claim 17, wherein the at least one securing structure comprises a latch fastener.

20. The plug electrical connector of claim 17, wherein the guiding recess extends into an inside of an insulating tubular member in a direction perpendicular to a row direction in which the plurality of insulating tubular members are arranged.

21. (canceled)

22. The plug electrical connector of claim 17, wherein the insulating cover member is wider toward the end of the mating contact.

23. The plug electrical connector of claim 17, wherein insulating tubular members of the plurality of insulating tubular members adjacent to one another in a row direction are joined together.

24. The plug electrical connector of claim 23, wherein the insulating housing has a recess at locations where the insulating tubular members adjacent to one another in the row direction are joined together.

25. A plug electrical connector, comprising:
an insulating housing comprising a plurality of insulating tubular members, the plurality of insulating tubular members being arranged in a single row, wherein a quantity of the plurality of insulating tubular members arranged in the single row is seven, and wherein at least one insulating tubular member of the plurality of insulating tubular members has a guiding recess extending along a plugging and unplugging direction of the plug electrical connector at an inner surface of the at least one insulating tubular member;
a plurality of mating contacts disposed in respective insulating tubular members of the plurality of insulating tubular members, wherein each mating contact of the plurality of mating contacts comprises an elongate metal structural member; and
at least one securing structure disposed on at least one end of the insulating housing,
wherein each mating contact of the plurality of mating contacts comprises an insulating cover member at an end of the mating contact.

26. The plug electrical connector of claim 25, wherein the plurality of mating contacts include a plurality of mating components that include tubular members.

27. The plug electrical connector of claim 25, wherein the at least one securing structure comprises a latch fastener.

28. The plug electrical connector of claim 25, wherein the guiding recess extends into an inside of an insulating tubular member in a direction perpendicular to a row direction in which the plurality of insulating tubular members are arranged.

29. The plug electrical connector of claim 25, wherein the insulating cover member is wider toward the end of the mating contact.

30. The plug electrical connector of claim 25, wherein insulating tubular members of the plurality of insulating tubular members adjacent to one another in a row direction are joined together.

31. The plug electrical connector of claim 30, wherein the insulating housing has a recess at locations where the insulating tubular members adjacent to one another in the row direction are joined together.

32. The plug electrical connector of claim 25, each of the plurality of mating contacts comprises an elongate metal structural member, and wherein at least one of the plurality of mating contacts is recessed from an end of a corresponding insulating tubular member.
